(19) United States
(12) Patent Application Publication
(10) Pub. No.: US 2018/0208202 A1
(43) Pub. Date: Jul. 26, 2018

(54) CONTROL DEVICE

(71) Applicant: AISIN AW CO., LTD., Anjo-shi, Aichi-ken (JP)

(72) Inventors: Hirokazu KOBAYASHI, Nishio (JP); Kohei TSUDA, Nishio (JP); Keiichirou KUSABE, Okazaki (JP); Takashi YOSHIDA, Nishio (JP)

(73) Assignee: AISIN AW CO., LTD., Anjo-shi, Aichi-ken (JP)

(21) Appl. No.: 15/743,910

(22) PCT Filed: Sep. 8, 2016
(86) PCT No.: PCT/JP2016/076514

§ 371 Date: Jan. 11, 2018

(30) Foreign Application Priority Data
Sep. 30, 2015 (JP) 2015-194822

(51) Int. Cl. B60W 30/20; B60K 6/48; B60K 6/547; B60W 10/02; B60W 10/06; B60W 10/08; B60W 10/11; B60W 20/40

(52) U.S. Cl. CPC B60W 30/20; Y10S 903/945; B60K 6/547; B60W 10/02; B60W 10/06; B60W 10/08; B60W 10/11; B60W 20/40; B60W 2030/203; B60W 2030/206; B60W 2510/0208; B60W 2510/0241; B60W 2510/0638; B60W 2510/081; B60W 2510/1005; B60W 2710/021; B60W 2710/025; B60W 2710/0644; B60W 2710/083; B60W 2710/1005; B60W 2710/027; B60W 2720/30; B60Y 2200/92; Y10S 903/93; Y10S 903/946; B60K 6/48

(57) ABSTRACT

To avoid occurrence of difference in level of torque in a case where direction of relative rotation between internal combustion engine and rotary electric machine is reversed, in starting internal combustion engine with shift clutch device brought into direct engagement state. Control device controls vehicle drive device including transfer clutch device, rotary electric machine, and transmission device each disposed on power transfer path connecting internal combustion engine to wheels. In performing internal combustion engine start control, control device reduces engagement pressure of transfer clutch device wherein transfer torque of transfer clutch device becomes zero on reverse in direction of relative rotation (T04), at which rotational speed (Ne) of internal combustion engine becomes higher than rotational speed (Nin) of rotary electric machine, in pre-transition completion period before transfer clutch device in slip engagement state is transitioned to direct engagement state, while maintaining transmission device at non-slip state.

### TECHNICAL FIELD

The present invention relates to a control device that controls a vehicle drive device as a control target.

### BACKGROUND ART

A hybrid vehicle has become commercially practical, which employs a combination of an internal combustion engine with a rotary electric machine as a source of driving force for wheels. A device disclosed in JP 2013-112190 A (Patent Literature 1) has been known as an example of a vehicle drive device for use in such a hybrid vehicle. The vehicle drive device in Patent Literature 1 includes a transfer clutch device [a first engagement device CL1], a rotary electric machine [a rotary electric machine MG], and a transmission device [a speed change mechanism TM] each disposed on a power transfer path connecting an internal combustion engine [an engine E] to wheels [wheels W].

When it becomes necessary to cause the vehicle that is running in an EV mode to mode transition from the EV mode to an HEV drive mode, a control device for the vehicle drive device in Patent Literature 1 performs internal combustion engine start control using a torque of the rotary electric machine, with the transfer clutch device brought into a slip engagement state. At this time, the control device reduces a shock to be caused in starting the internal combustion engine, by bringing into the slip engagement state one [a second engagement device CL2] of shift clutch devices of the transmission device.

According to the technique in Patent Literature 1, since one of the shift clutch devices is brought into the slip engagement state, the internal combustion engine start control is not performed until the shift clutch device starts to be slipped. Therefore, much time has been required for starting the internal combustion engine. Thus, a method of starting the internal combustion engine while bringing into a direct engagement state all shift clutch devices to be engaged in a situation in which the transmission device transfers power has been considered in order to quickly start the internal combustion engine. However, if a rotational speed of the internal combustion engine becomes higher than a rotational speed of the rotary electric machine during the performance of the internal combustion engine start control, a direction of relative rotation between the internal combustion engine and the rotary electric machine is reversed. As a result, a direction of a torque to be transferred via the transfer clutch device in the slip engagement state is changed from a direction transferred from a rotary electric machine side toward an internal combustion engine side to a direction transferred from the internal combustion engine side toward the rotary electric machine side. A difference in level thus occurs at a torque to be transferred from the side of the internal combustion engine and rotary electric machine to the transmission device. Therefore, in the case where all the shift clutch devices to be engaged in the situation in which the transmission device transfers power are maintained at the direct engagement state, there is a possibility that the difference in level of the torque is transferred to the wheels and is delivered as a shock to an occupant of the vehicle.

### CITATION LIST

### Patent Literature

Patent Literature 1: JP 2013-112190 A

### SUMMARY

### Technical Problem

A technique has been required for avoiding occurrence of a difference in level of a torque in a case where a direction of relative rotation between an internal combustion engine and a rotary electric machine is reversed, in starting the internal combustion engine with a shift clutch device brought into a direct engagement state.

### Solution to Problem

A control device according to the present disclosure is a control device for controlling a vehicle drive device, as a control target, including a transfer clutch device, a rotary electric machine, and a transmission device that includes one or more shift clutch devices, on a power transfer path connecting an internal combustion engine to a wheel,

a state in which, of the shift clutch devices, all shift clutch devices to be engaged in a situation in which the transmission device transfers power are directly engaged without being slipped is defined as a non-slip state of the transmission device,

the control device being configured to, in a situation in which the transfer clutch device is in a disengagement state, a situation in which a rotational speed of the rotary electric machine is equal to or more than a startable rotational speed of the internal combustion engine, and a situation in which the transmission device is in the non-slip state and a torque of the rotary electric machine is transferred to the wheel to drive a vehicle, perform internal combustion engine start control of bringing the transfer clutch device into a slip engagement state and increasing a rotational speed of the internal combustion engine to start the internal combustion engine,

the control device being configured to set a target torque that is a target value of an output torque from the rotary electric machine at a sum of a wheel required torque that is a torque required for driving the wheel and a transfer torque of the transfer clutch device in the slip engagement state to control the output torque from the rotary electric machine, during the performance of the internal combustion engine start control,

the control device being configured to perform rotational speed control on the internal combustion engine to increase the rotational speed of the internal combustion engine to a rotational speed higher than the rotational speed of the rotary electric machine in a pre-transition completion period before the transfer clutch device in the slip engagement state is transitioned to a direct engagement state, while maintaining the transmission device at the non-slip state, after the start of the internal combustion engine,

the control device being configured to reduce an engagement pressure of the transfer clutch device such that the transfer torque of the transfer clutch device becomes zero, on a reverse in a direction of relative rotation, at which the gradually increasing rotational speed of the internal combustion engine becomes higher than the rotational speed of the rotary electric machine, in the pre-transition completion period.

With this configuration, during the performance of the internal combustion engine start control, all the shift clutch devices to be engaged in the situation in which the transmission device transfers power are maintained at the state being directly engaged without being slipped. None of the shift clutch devices are slipped to begin with. Therefore, there is no possibility that torque fluctuation incident to slip start and re-direct coupling is transferred to the wheel to cause a shock.

Moreover, a combination of rotational speed control for the rotary electric machine with the control for the output torque from the rotary electric machine with the wheel required torque and the transfer torque of the transfer clutch device taken into consideration enables minimization of the range of fluctuation in an input torque to the transmission device. It is hence possible to minimize the torque fluctuation to be transferred to the wheel and to reduce a shock, without causing the shift clutch device to be slipped, in the period before starting the internal combustion engine.

It is accordingly possible to reduce a shock to be delivered to an occupant of the vehicle, in the entire period from the pre-transition completion period to the timing at which the transfer clutch device is directly engaged.

In addition, the rotational speed of the internal combustion engine is increased once to the rotational speed higher than the rotational speed of the rotary electric machine, in the pre-transition completion period. Therefore, the direction of torque transfer via the transfer clutch device is invariant before and after the direct engagement of the transfer clutch device. It is hence possible to minimize a difference in level of a torque to be input to the transmission device before and the after the direct engagement of the transfer clutch device. It is therefore possible to reduce an engagement shock incident to the direct engagement of the transfer clutch device.

In this case, the transfer torque of the transfer clutch device brought into the slip engagement state in order to start the internal combustion engine is brought to be zero on the reverse in the direction of relative rotation, at which the direction of relative rotation between the internal combustion engine and the rotary electric machine is reversed. It is hence possible to avoid occurrence of a difference in level of a torque before and after the reverse in the direction of relative rotation, at which a difference in level inevitably occurs at a torque to be input to the transmission device in a case where the transfer clutch device has a transfer torque.

It is accordingly possible to start the internal combustion engine without causing an occupant of the vehicle to feel a shock in a case where a request to start the internal combustion engine comes in.

Additional features and advantages of the technique according to the present disclosure will become more apparent from illustrative and non-limiting embodiments to be described below with reference to the drawings.

### BRIEF DESCRIPTION OF DRAWINGS

FIG. 1 is a schematic diagram of a vehicle drive device according to an embodiment.

FIG. 2 is a block diagram illustrating a schematic configuration of a control device.

FIG. 3 is a flowchart illustrating processing procedures of internal combustion engine start control (including special start control).

FIG. 4 is a timing chart illustrating an example of the internal combustion engine start control (including the special start control).

FIG. 5 is a schematic diagram of a vehicle drive device according to another embodiment.

FIG. 6 is a schematic diagram of a vehicle drive device according to still another embodiment.

### DESCRIPTION OF EMBODIMENTS

An embodiment of a control device will be described below. This control device 1 is a vehicle drive device control device that controls a vehicle drive device 3 as a control target. In the present embodiment, the control device 1 is an electronic control unit (ECU). The vehicle drive device 3 to be controlled as a control target by the control device 1 is a drive device (a hybrid vehicle drive device) that drives a vehicle (a hybrid vehicle) equipped with an internal combustion engine EG and a rotary electric machine 33 each serving as a source of driving force for wheels W. The vehicle drive device 3 is constituted as a parallel hybrid vehicle drive device that drives a hybrid vehicle of a parallel type.

In the following description, a term “drivingly coupled” means a situation in which two rotating elements are coupled to each other such that driving force (synonymous with torque) is transferable therebetween. This concept includes a situation in which two rotating elements are coupled to each other so as to rotate together with each other and a situation in which two rotating elements are coupled to each other such that driving force is transferable therebetween via at least one transmission member. Examples of such a transmission member include various members (e.g., a shaft, a gear mechanism, a belt) that transfer rotation at a fixed rotational speed or while changing a rotational speed, and may include clutch devices (e.g., a friction clutch device, a meshing clutch device) that selectively transfer rotation and driving force.

The term “rotary electric machine” is used as a concept including all of a motor (an electric motor), a generator (an electric generator), and a motor-generator that functions as a motor and a generator as necessary.

In addition, with regard to a state of engagement of a friction clutch device, a term “engagement state” means a state in which a transfer torque capacity is generated at the friction clutch device. As used herein, the transfer torque capacity refers to a maximum torque that is transferable by friction from the friction clutch device. The magnitude of the transfer torque capacity is determined in proportion to a pressure (an engagement pressure) at which two clutch members (an input-side clutch member, an output-side clutch member) of the friction clutch device are mutually pressed against each other. The term “engagement state” includes a “direct engagement state” in which there is no rotational speed difference (slip) between the clutch members and a “slip engagement state” in which there is a rotational speed difference between the clutch members. A term “disengagement state” means a state in which no transfer torque capacity is generated at the friction clutch device or a state that is not intended to cause a transfer torque capacity to be generated at the friction clutch device. In the present embodiment, the direct engagement state and the disengagement state, each of which is a “state other than the slip engagement state”, are collectively referred to as a “non-slip engagement state”.

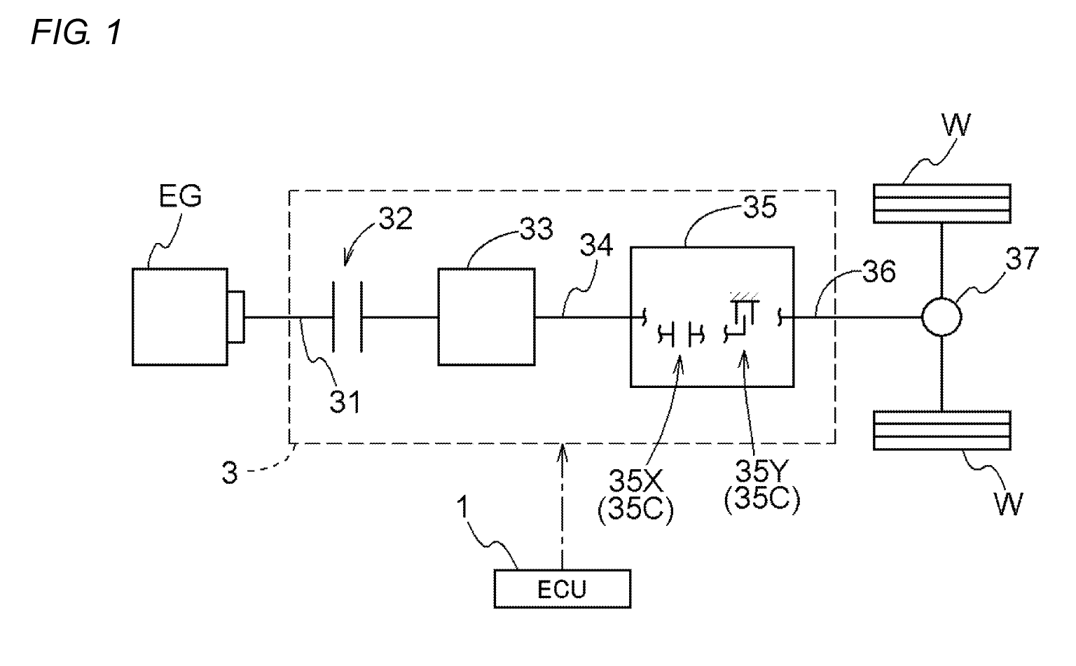

As illustrated in FIG. 1, the vehicle drive device 3 includes a transfer clutch device 32, the rotary electric machine 33, and a transmission device 35 each disposed on a power transfer path connecting the internal combustion engine EG to the wheels W. The vehicle drive device 3 also includes an input member 31, a shift input member 34, and an output member 36 in order to transfer rotation and driving force between the constituents on the power transfer path. The input member 31, the transfer clutch device 32, the rotary electric machine 33, the shift input member 34, the transmission device 35, and the output member 36 are arranged in the described order from the internal combustion engine EG side on the power transfer path.

The input member 31 is drivingly coupled to the internal combustion engine EG. The internal combustion engine EG is a prime mover (e.g., a gasoline engine, a diesel engine) that is driven by fuel combustion inside the engine to output motive power. The input member 31 is constituted of, for example, a shaft member (an input shaft). The input member 31 is drivingly coupled to an internal combustion engine output member (e.g., a crankshaft) that is an output member of the internal combustion engine EG so as to rotate together with the internal combustion engine output member. Accordingly, a rotational speed of the input member 31 is equal to a rotational speed Ne of the internal combustion engine EG. It should be noted that the input member 31 and the internal combustion engine output member may be directly coupled to each other or may be coupled to each other via another member such as a damper. The input member 31 is drivingly coupled to the rotary electric machine 33 via the transfer clutch device 32.

The transfer clutch device 32 selectively couples the input member 31 to the rotary electric machine 33. In other words, the transfer clutch device 32 is provided to be capable of disengaging the coupling between the internal combustion engine EG and the rotary electric machine 33. The transfer clutch device 32 functions as an internal combustion engine disconnection clutch device to disconnect the internal combustion engine EG from the wheels W. In the present embodiment, the transfer clutch device 32 is a friction clutch device. Examples of the friction clutch device may include a wet multi-plate clutch and the like.

The rotary electric machine 33 includes a stator fixed to a casing that is a non-rotatable member, and a rotor rotatably supported on a radially inner side of the stator. The rotary electric machine 33 is connected to an electric power storage device via an inverter device. The rotary electric machine 33 receives electric power supplied from the electric power storage device to perform powering. Alternatively, the rotary electric machine 33 supplies, to the electric power storage device, electric power generated by, for example, a torque of the internal combustion engine EG or an inertial force of the vehicle. The electric power storage device stores the electric power thus generated. The rotor of the rotary electric machine 33 is coupled to the shift input member 34 so as to rotate together with the shift input member 34. Accordingly, a rotational speed Nin of the shift input member 34 is equal to a rotational speed of the rotary electric machine 33 (the rotor). The shift input member 34 is constituted of, for example, a shaft member (a shift input shaft). The shift input member 34 that rotates together with the rotor is drivingly coupled to the transmission device 35.

In the present embodiment, the transmission device 35 is constituted as a stepped automatic transmission device. The transmission device 35 of the present embodiment includes, for example, a planetary gear mechanism (not illustrated) and one or more shift clutch devices 35C. The shift clutch devices 35C include at least one clutch 35X and at least one brake 35Y. In the present embodiment, each of the clutch 35X and the brake 35Y constituting the shift clutch devices 35C is a friction clutch device. Examples of the friction clutch device may include a wet multi-plate clutch, a wet multi-plate brake, and the like. It should be noted that the shift clutch devices 35C may include at least one one-way clutch.

The transmission device 35 is capable of selectively establishing any of multiple shift speeds in accordance with a state of engagement of each shift clutch device 35C (the direct engagement state or the disengagement state particularly in the present embodiment).

For example, the transmission device 35 brings two of the shift clutch devices 35C into the direct engagement state to establish a shift speed corresponding to a combination of the engaged shift clutch devices 35C. The transmission device 35 changes the rotational speed Nin of the shift input member 34, based on a speed ratio corresponding to the established shift speed, and transfers the changed rotational speed Nin to the output member 36. It should be noted that the term “speed ratio” refers to a ratio of the rotational speed Nin of the shift input member 34 to a rotational speed of the output member 36 and is calculated as a value obtained by dividing the rotational speed Nin of the shift input member 34 by the rotational speed of the output member 36. The output member 36 is constituted of, for example, a shaft member (an output shaft).

The output member 36 is drivingly coupled to the right and left wheels W, provided in a pair, via a differential gear device 37. A torque transferred to the output member 36 is distributed and transferred to the two, right and left, wheels W via the differential gear device 37. The vehicle drive device 3 is thus capable of transferring one of, or both of, a torque of the internal combustion engine EG and a torque of the rotary electric machine 33 to the wheels W to drive the vehicle.

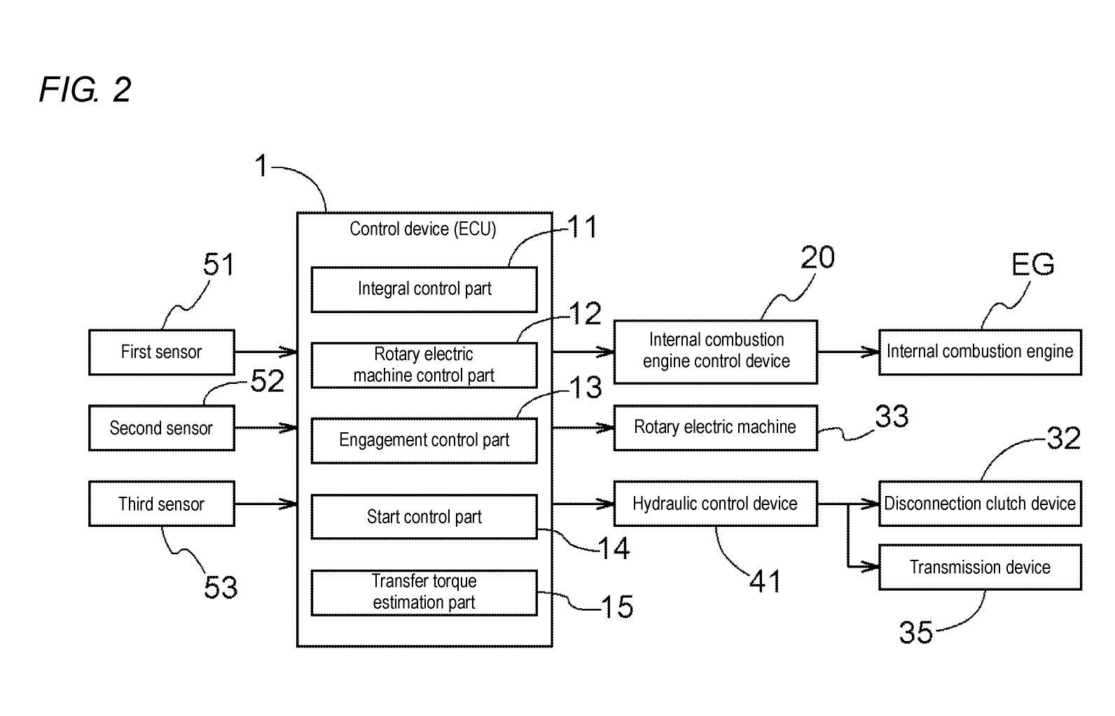

As illustrated in FIG. 2, the control device 1 that functions as a core performing operation control on each constituent of the vehicle drive device 3 includes an integral control part 11, a rotary electric machine control part 12, an engagement control part 13, a start control part 14, and a transfer torque estimation part 15. Each of these functional parts is constituted of software (a program) stored in a storage medium such as a memory, hardware such as an arithmetic circuit provided separately, or a combination of software with hardware. The functional parts are configured to be capable of exchanging information with one another. In addition, the control device 1 is configured to be capable of acquiring information on results of detection by various sensors (a first sensor 51, a second sensor 52, a third sensor 53) provided for the respective sections of the vehicle on which the vehicle drive device 3 is mounted.

The first sensor 51 detects a rotational speed of the input member 31 and a member (e.g., the internal combustion engine EG) that rotates together with the input member 31. The second sensor 52 detects a rotational speed of the shift input member 34 and a member (e.g., the rotary electric machine 33) that rotates together with the shift input member 34. The third sensor 53 detects a rotational speed of the output member 36 or a rotational speed of a member (e.g., the wheels W) that rotates synchronously with the output member 36. It should be noted that the term “rotate synchronously” means to rotate at a rotational speed proportional to a reference rotational speed. The control device 1 is capable of calculating a vehicle speed, based on a result of detection by the third sensor 53. In addition to the information described above, the control device 1 is configured to be capable of acquiring information such as an accelerator opening, a brake operation amount, and an amount of electric power stored in the electric power storage device.

The integral control part 11 performs control to integrate various kinds of control (e.g., torque control, rotational speed control, engagement control) to be performed on, for example, the internal combustion engine EG, the rotary electric machine 33, the transfer clutch device 32, and the transmission device 35 (the shift clutch devices 35C) as a whole of the vehicle. The integral control part 11 calculates a wheel required torque Tw that is a torque required for driving the wheels W (or a vehicle required torque that is a torque required for driving the vehicle), based on the sensor detected information (mainly, the information on the accelerator opening and the vehicle speed). Preferably, for example, a relation between an accelerator opening and a vehicle speed and a wheel required torque Tw corresponding to the accelerator opening and the vehicle speed is stored in the form of, for example, a map or a relational expression, and the integral control part 11 calculates the wheel required torque Tw, based on the map, the relational expression or the like and the accelerator opening and the vehicle speed at this time.

In addition, the integral control part 11 decides a drive mode, based on the sensor detected information (mainly, the information on the accelerator opening, the vehicle speed, and the amount of electric power stored in the electric power storage device). In the present embodiment, the drive mode selectable by the integral control part 11 includes an electric drive mode (hereinafter, referred to as an “EV mode”) and a hybrid drive mode (hereinafter, referred to as an “HEV mode”). The EV mode refers to a drive mode in which only a torque of the rotary electric machine 33 is transferred to the wheels W to drive the vehicle. The HEV mode refers to a drive mode in which a torque of the internal combustion engine EG and a torque of the rotary electric machine 33 are transferred to the wheels W to drive the vehicle.

The integral control part 11 decides an output torque (an internal combustion engine required torque) required of the internal combustion engine EG and an output torque (a rotary electric machine required torque) required of the rotary electric machine 33, based on the decided drive mode, the sensor detected information, and the like. The integral control part 11 decides, for example, a state of engagement of the transfer clutch device 32 and a target shift speed to be established by the transmission device 35, based on the decided drive mode, the sensor detected information, and the like.

In the present embodiment, the control device 1 (the integral control part 11) controls operating points (an output torque, a rotational speed Ne) of the internal combustion engine EG via an internal combustion engine control device 20. The internal combustion engine control device 20 is capable of performing torque control and rotational speed control on the internal combustion engine EG in accordance with, for example, a running state of the vehicle. The torque control for the internal combustion engine EG refers to control of sending a command as to a target torque to the internal combustion engine EG and causing an output torque from the internal combustion engine EG to follow this target torque. The rotational speed control for the internal combustion engine EG refers to control of sending a command as to a target rotational speed Net to the internal combustion engine EG and deciding an output torque so as to cause the rotational speed Ne of the internal combustion engine EG to follow this target rotational speed Net. It should be noted that the internal combustion engine control device 20 is also capable of performing the torque control and the rotational speed control for the internal combustion engine EG in combination.

The rotary electric machine control part 12 controls operating points (an output torque, a rotational speed) of the rotary electric machine 33. The rotary electric machine control part 12 is capable of performing torque control and rotational speed control on the rotary electric machine 33 in accordance with, for example, a running state of the vehicle. The torque control for the rotary electric machine 33 refers to control of sending a command as to a target torque Tmt to the rotary electric machine 33 and causing an output torque from the rotary electric machine 33 to follow this target torque Tmt. The rotational speed control for the rotary electric machine 33 refers to control of sending a command as to a target rotational speed Nmt to the rotary electric machine 33 and deciding an output torque so as to cause a rotational speed of the rotary electric machine 33 to follow this target rotational speed Nmt. It should be noted that the rotary electric machine control part 12 is also capable of performing the torque control and the rotational speed control for the rotary electric machine 33 in combination.

The engagement control part 13 controls a state of engagement of the transfer clutch device 32, and a state of engagement of each of a plurality of shift clutch devices 35C of the transmission device 35. In the present embodiment, the transfer clutch device 32 and the plurality of shift clutch devices 35C are hydraulically-driven friction clutch devices. The engagement control part 13 controls oil pressures to be supplied to the transfer clutch device 32 and each shift clutch device 35C, via a hydraulic control device 41, thereby controlling the state of engagement of the transfer clutch device 32 and the state of engagement of each shift clutch device 35C.

An engagement pressure of each clutch device changes in proportion to the magnitude of an oil pressure supplied to the corresponding clutch device. In accordance with this, the magnitude of a transfer torque capacity generated at each clutch device changes in proportion to the magnitude of an oil pressure to be supplied to the corresponding clutch device. The state of engagement of each clutch device is controlled to be set at any of the direct engagement state, the slip engagement state, and the disengagement state, in accordance with an oil pressure to be supplied. The hydraulic control device 41 includes a hydraulic control valve (e.g., a linear solenoid valve) that regulates an oil pressure of a hydraulic oil to be supplied from an oil pump (not illustrated). The oil pump may be, for example, a mechanical pump to be driven by the input member 31 or the shift input member 34, or may be, for example, an electric pump to be driven by a rotary electric machine for a pump. The hydraulic control device 41 regulates an opening of the hydraulic control valve in accordance with an oil pressure command from the engagement control part 13, thereby supplying to each clutch device a hydraulic oil with an oil pressure responsive to this oil pressure command.

The engagement control part 13 controls the state of engagement of the transfer clutch device 32 so as to set a drive mode decided by the integral control part 11. For example, the engagement control part 13 controls the transfer clutch device 32 so as to bring the transfer clutch device 32 into the disengagement state when the EV mode is set and controls the transfer clutch device 32 so as to bring the transfer clutch device 32 into the direct engagement state when the HEV mode is set.

In addition, the engagement control part 13 controls the state of engagement of each of the plurality of shift clutch device 35C so as to establish a target shift speed decided by the integral control part 11. The engagement control part 13 controls two of the shift clutch devices 35C in accordance with the target shift speed so as to bring the two shift clutch devices 35C into the direct engagement state and controls all the remaining shift clutch devices 35C so as to bring the remaining shift clutch devices 35C into the disengagement state.

In a normal running state and during an operation other than a shift operation, of the plurality of shift clutch devices 35C, all shift clutch devices 35C to be engaged in a situation in which the transmission device 35 transfers power are brought into a state being directly engaged without being slipped. In the present embodiment, this state is referred to as a “non-slip state” of the transmission device 35. The “non-slip state” of the transmission device 35 refers to a state in which all the shift clutch devices 35C are brought into the direct engagement state or the disengagement state in accordance with a target shift speed (i.e., a state in which all the shift clutch devices 35C are brought into the non-slip engagement state).

In mode transition from the EV mode to the HEV mode, the start control part 14 performs internal combustion engine start control of starting the internal combustion engine EG. The vehicle is driven to run in the EV mode in such a manner that a torque of the rotary electric machine 33 is transferred to the wheels W with the transfer clutch device 32 brought into the disengagement state and the transmission device 35 brought into the non-slip state. In this situation, when a mode transition request to the HEV mode (an internal combustion engine start request) is issued because of, for example, an increase of a wheel required torque Tw or a reduction in an amount of electric power stored in the electric power storage device, the start control part 14 performs the internal combustion engine start control. In the internal combustion engine start control, the start control part 14 brings the transfer clutch device 32 into the slip engagement state, in cooperation with the engagement control part 13. Preferably, a transfer torque capacity of the transfer clutch device 32 to be brought into the slip engagement state is set in accordance with, for example, a driven torque (an inertial torque) of the internal combustion engine EG which has been stationary and each of the various members rotating together with the internal combustion engine EG. The start control part 14 thus increases the rotational speed Ne of the internal combustion engine EG and starts the internal combustion engine EG, using a torque of the rotary electric machine 33, the torque being transferred from the rotary electric machine 33 side toward the internal combustion engine EG side via the transfer clutch device 32 in the slip engagement state.

In the known art, one of the plurality of shift clutch devices 35C has been brought into the slip engagement state for the purpose of reducing a shock to be caused in starting the internal combustion engine EG (a start shock). More specifically, of the plurality of shift clutch devices 35C, at least one of the shift clutch devices 35C to be engaged in a situation in which the transmission device 35 transfers power is slipped without being directly engaged, and the internal combustion engine start control is performed with the transmission device 35 brought into a “slip state” in some cases. In contrast to this, the start control part 14 of the present embodiment performs a series of control while maintaining the transmission device 35 at the non-slip state, in performing the internal combustion engine start control. Since none of the shift clutch devices 35C are slipped while being maintained at the direct engagement state or the disengagement state, the internal combustion engine EG can be started with good responsivity relative to a start request. In addition, since there is no torque fluctuation incident to slip start and re-direct coupling of the shift clutch devices 35C, there is no possibility that torque fluctuation is transferred to the wheels W to cause a shock.

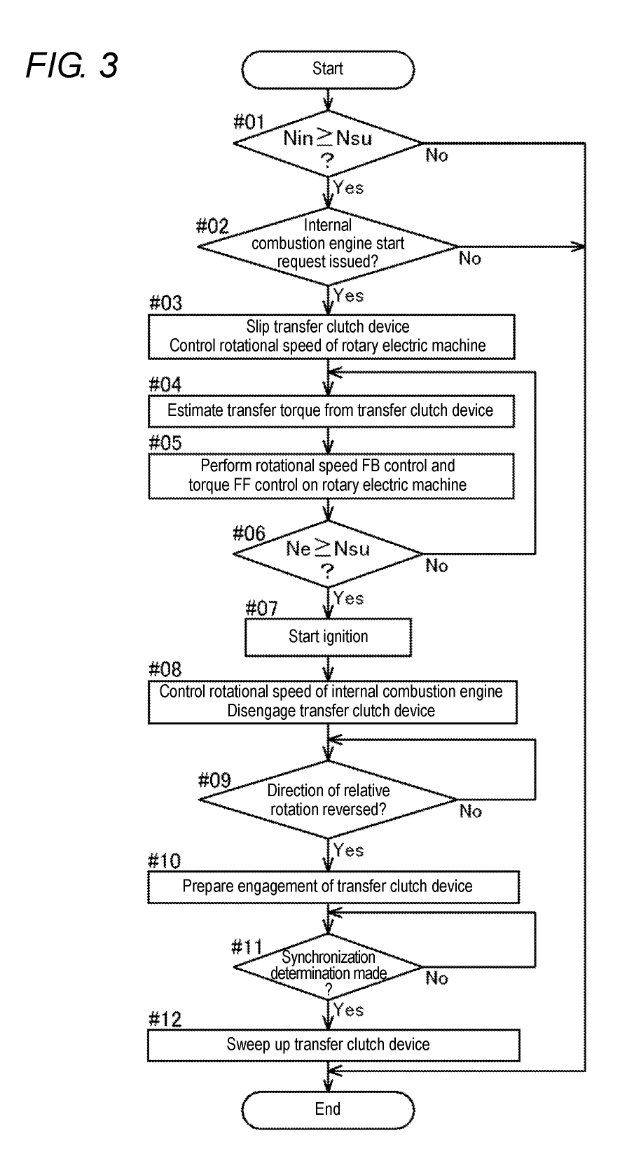

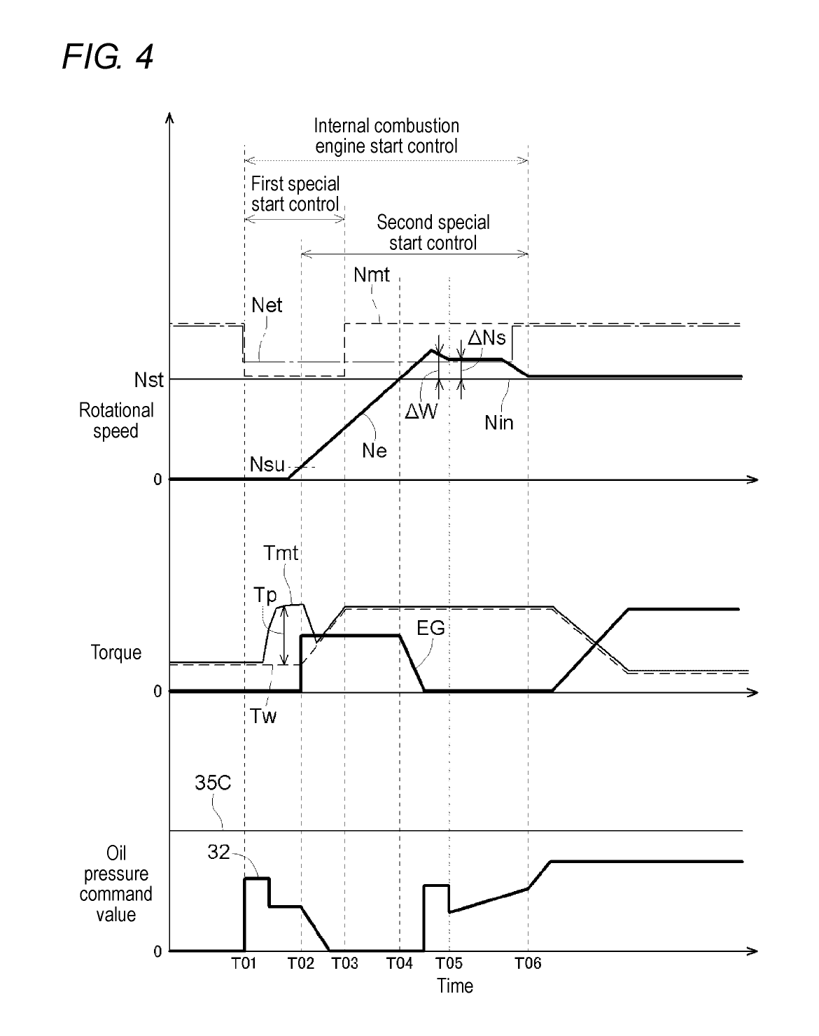

The start control part 14 of the present embodiment performs, in addition to the normal internal combustion engine start control, special start control such that a start shock is not caused so much even when the internal combustion engine start control is performed with the transmission device 35 maintained at the non-slip state. The special start control includes first special start control to be performed in a pre-start period before the internal combustion engine EG stably starts self-sustaining, and second special start control to be performed in a pre-transition completion period before the transfer clutch device 32 in the slip engagement state is transitioned to a direct engagement state. Hereinafter, specific examples of the internal combustion engine start control and special start control to be performed by the start control part 14 as a core will be described with reference to FIGS. 3 and 4. It is assumed in the following example that the transfer clutch device 32 is brought into the disengagement state with the combustion of the internal combustion engine EG kept off, and the vehicle is driven to run in the EV mode. It is also assumed that a wheel required torque Tw is calculated at all times.

As illustrated in FIG. 3, first, it is determined whether a rotational speed Nin of the shift input member 34 that rotates together with the rotary electric machine 33 is equal to or more than a startable rotational speed Nsu of the internal combustion engine EG (step #01). The startable rotational speed Nsu is a rotational speed at which the internal combustion engine EG is capable of continuous self-sustaining after the start of the internal combustion engine EG, and is set at, for example, a rotational speed around an idle rotational speed. In the present embodiment, when the rotational speed Nin of the shift input member 34 is less than the startable rotational speed Nsu of the internal combustion engine EG (#01: No), the control is terminated without actually starting the internal combustion engine EG. One of conditions for the start is that the rotational speed Nin of the shift input member 34 is on a certain level or more, because the rotational speed Ne of the internal combustion engine EG is raised to the startable rotational speed Nsu or more so as to reliably enable self-sustaining even when the transmission device 35 is maintained at the non-slip state. Hereinafter, it is assumed in this example that the rotational speed Nin of the shift input member 34 is set at a set start rotational speed Nst higher than the startable rotational speed Nsu.

In a case where the rotational speed Nin of the shift input member 34 is equal to or more than the startable rotational speed Nsu of the internal combustion engine EG (#01: Yes), when an internal combustion engine start request (a mode transition request from the EV mode to the HEV mode) is issued (#02: Yes), the first special start control is performed. This first special start control is performed in at least a period before starting the internal combustion engine EG (a pre-start period) during the performance of the internal combustion engine start control. In the first special start control, the transfer clutch device 32 which has been brought into the disengagement state is brought into the slip engagement state, and rotational speed control (rotational speed feedback control) is performed on the rotary electric machine 33 (#03/times T01 to T02). In the present embodiment, a target rotational speed Nmt of the rotary electric machine 33 is maintained at the set start rotational speed Nst in the rotational speed control for the rotary electric machine 33. Thus, the actual rotational speed of the rotary electric machine 33 is maintained at the startable rotational speed Nsu or more (the set start rotational speed Nst in this example).

When the transfer clutch device 32 is brought into the slip engagement state, a torque of the rotary electric machine 33 is transferred from the rotary electric machine 33 side toward the internal combustion engine EG side via the transfer clutch device 32 in the slip engagement state. In the present embodiment, the magnitude of the torque to be transferred via the transfer clutch device 32 in the slip engagement state is estimated in this situation (#04). Therefore, the control device 1 of the present embodiment further includes the transfer torque estimation part 15 that estimates an actual transfer torque of the transfer clutch device 32 (see FIG. 2).

The actual transfer torque of the transfer clutch device 32 is estimated based on, for example, an oil pressure command value for the transfer clutch device 32. The actual transfer torque of the transfer clutch device 32 increases with a certain delay relative to the oil pressure command value. The increase in the actual transfer torque of the transfer clutch device 32 with this control delay can be theoretically represented by a certain function (a relational expression). Therefore, the transfer torque of the transfer clutch device 32 is preferably estimated based on a state of change in an oil pressure command value and a time elapsed from the start of this change. Hereinafter, the estimated transfer torque of the transfer clutch device 32 is represented using algebra “Tp” in some cases.

It should be noted that the increase in the actual transfer torque of the transfer clutch device 32 with the control delay may vary depending on a specific structure of the vehicle drive device 3. Therefore, for example, the followability of the actual transfer torque of the transfer clutch device 32 relative to the oil pressure command value that changes in a prescribed pattern is stored and prepared in the form of, for example, a map or a relational expression, every vehicle drive devices 3 different in structure from one another. The transfer torque of the transfer clutch device 32 may be estimated based on the map, the relational expression, or the like, the oil pressure command value, and the elapsed time. In addition, the transfer torque of the transfer clutch device 32 may be estimated in consideration of an influence of a temperature of a hydraulic oil, the influence being exerted on the transfer clutch device 32. The transfer torque of the transfer clutch device 32 may also be estimated in consideration of an influence of a disturbance torque, such as a running resistance torque or a brake torque, to be produced on the running of the vehicle.

Next, torque control (output torque feedforward control) is performed on the rotary electric machine 33 in parallel with the rotational speed control for the rotary electric machine 33 (#05/T01 to T03). In the rotational speed control for the rotary electric machine 33, the target rotational speed Nmt of the rotary electric machine 33 is maintained at the set start rotational speed Nst as described above. In the torque control for the rotary electric machine 33, a target torque Tmt that is a target value of the output torque from the rotary electric machine 33 is set to be a sum of the wheel required torque Tw and the estimated transfer torque Tp from the transfer clutch device 32 (Tmt=Tw+Tp). With this configuration, it is possible to effectively avoid a drop in a torque to be transferred from the rotary electric machine 33 to the wheels W side in starting the internal combustion engine EG with the transfer clutch device 32 slipped, even when the transmission device 35 is maintained at the non-slip state. Accordingly, the wheel required torque Tw can be satisfied appropriately, and an unintended deceleration feeling is not given to an occupant of the vehicle.

The rotational speed Ne of the internal combustion engine EG starts to increase by the torque of the rotary electric machine 33, the torque being transferred via the transfer clutch device 32 in the slip engagement state. Thereafter, when the rotational speed Ne of the internal combustion engine EG becomes equal to or more than the startable rotational speed Nsu (#06: Yes/T02), spark ignition is started (#07). In the present embodiment, the rotational speed control and torque control for the rotary electric machine 33 in the first special start control are continuously performed for a while after the start of spark ignition. The rotational speed control and torque control for the rotary electric machine 33 are continuously performed until an appropriate point in time (T03) before synchronization of the internal combustion engine EG with the rotary electric machine 33.

After the start of spark ignition, the second special start control is performed in the pre-transition completion period before the transfer clutch device in the slip engagement state is transitioned to a direct engagement state. In this way, the first special start control and the second special start control may be performed in parallel so as to partially overlap each other. In the second special start control, the rotational speed control is performed on the internal combustion engine EG, and the transfer clutch device 32, which has been brought into the slip engagement state, is brought into the disengagement state (#08). It should be noted that the rotational speed control for the internal combustion engine EG may be performed in course of the performance of the first special start control, as illustrated in the example of FIG. 4. In the rotational speed control for the internal combustion engine EG, the target rotational speed Net of the internal combustion engine EG is set at a rotational speed higher than the rotational speed of the rotary electric machine 33 (the rotational speed Nin of the shift input member 34). In the present embodiment, the target rotational speed Net is set at a rotational speed higher by a synchronization determination differential rotational speed ΔNs (to be described later) than the rotational speed of the rotary electric machine 33 (the rotational speed Nin of the shift input member 34). In the pre-transition completion period, thus, the rotational speed Ne of the internal combustion engine EG is increased once to the rotational speed higher by the synchronization determination differential rotational speed ΔNs than the rotational speed of the rotary electric machine 33. In a case where overshooting occurs due to a control delay, the rotational speed Ne of the internal combustion engine EG is increased once beyond the rotational speed higher by the synchronization determination differential rotational speed ΔNs than the rotational speed of the rotary electric machine 33.

The oil pressure command value for the transfer clutch device 32 which has been brought into the slip engagement state is reduced at a certain time rate of change after the start of spark ignition, so that the transfer clutch device 32 is brought into the disengagement state. The oil pressure command value for the transfer clutch device 32 is reduced to, for example, zero. Thus, the engagement pressure of (the oil pressure command value for) the transfer clutch device 32 is reduced such that the transfer torque of the transfer clutch device 32 becomes zero on a reverse in a direction of relative rotation (T04), at which the gradually increasing rotational speed Ne of the internal combustion engine EG becomes higher than the rotational speed of the rotary electric machine 33. In this example, the transfer torque of the transfer clutch device 32 is brought to be zero at a point in time before a time T03 at which the rotational speed control and torque control for the rotary electric machine 33 in the first special start control are terminated.

In a situation in which the rotational speed Ne of the internal combustion engine EG is lower than the rotational speed of the rotary electric machine 33, a torque is transferred from the rotary electric machine 33 side toward the internal combustion engine EG side via the transfer clutch device 32 in the slip engagement state. Thereafter, when the rotational speed Ne of the internal combustion engine EG becomes higher than the rotational speed of the rotary electric machine 33, the torque is transferred from the internal combustion engine EG side toward the rotary electric machine 33 side via the transfer clutch device 32 in the slip engagement state. Therefore, in a case where the transfer clutch device 32 has a transfer torque before and after the reverse in the direction of relative rotation, at which the direction of relative rotation between the internal combustion engine EG and the rotary electric machine 33 is reversed, a difference in level inevitably occurs at the torque to be transferred to the shift input member 34. In a case where the transmission device 35 is maintained at the non-slip state during the performance of the internal combustion engine start control as described in the present embodiment, the difference in level of the torque to be transferred to the shift input member 34 is delivered as it is as a shock to an occupant of the vehicle.

In this respect, according to the present embodiment, the transfer torque of the transfer clutch device 32 which has been brought into the slip engagement state in order to start the internal combustion engine EG is reduced again and then is brought to be zero on the reverse in the direction of relative rotation. It is therefore possible to avoid occurrence of the difference in level of the torque before and after the reverse in the direction of relative rotation and to reduce a shock to be delivered to an occupant of the vehicle.

When the rotational speed Ne of the internal combustion engine EG becomes higher than the rotational speed of the rotary electric machine 33 and the direction of relative rotation between the internal combustion engine EG and the rotary electric machine 33 is reversed (#09: Yes/T04), then preparation for re-engagement of the transfer clutch device 32 is started (#10). In the case where the oil pressure command value for the transfer clutch device 32 is reduced to zero before the reverse in the direction of relative rotation as described in the present embodiment, a hydraulic oil is precharged into the transfer clutch device 32, and then the oil pressure command value for the transfer clutch device 32 is set as a predetermined value (T05).

In addition, a synchronization determination is made on the internal combustion engine EG and the rotary electric machine 33 while the rotational speed control is performed on the internal combustion engine EG (#11). The synchronization determination between the internal combustion engine EG and the rotary electric machine 33 can be made based on, for example, a fact that an actual rotational speed difference ΔW between two clutch members of the transfer clutch device 32 is not more than the previously determined synchronization determination differential rotational speed ΔNs. The synchronization determination differential rotational speed ΔNs is previously determined as a value that can be regarded as no difference between the rotational speeds of the two clutch members. The synchronization determination differential rotational speed ΔNs may be appropriately set within a range from 20 to 100 [rpm], for example.

In the case where the target rotational speed Net in the rotational speed control for the internal combustion engine EG is set at the rotational speed higher by the synchronization determination differential rotational speed ΔNs than the rotational speed of the rotary electric machine 33 (the rotational speed Nin of the shift input member 34) as described in the present embodiment, the synchronization determination may be made based on a fact that the rotational speed Ne of the internal combustion engine EG stably follows the target rotational speed Net. In this case, in a case where the rotational speed Ne of the internal combustion engine EG is increased once to the rotational speed higher by the synchronization determination differential rotational speed ΔNs than the rotational speed of the rotary electric machine 33 due to, for example, overshooting, the synchronization determination may be made based on a fact that the rotational speed Ne of the internal combustion engine EG, which is then gradually reduced, stably follows the target rotational speed Net.

When a positive result of determination is obtained as to the synchronization determination made on the internal combustion engine EG and the rotary electric machine 33 (#11: Yes/T05), that is, when the actual rotational speed difference ΔW between the two clutch members becomes not more than the synchronization determination differential rotational speed ΔNs, the oil pressure command value for the transfer clutch device 32 is gradually increased (#12/T05 to T06). Thus, the engagement pressure of the transfer clutch device 32 is gradually increased. At this time, the engagement pressure of the transfer clutch device 32 is gently increased while the transmission device 35 is continuously maintained at the non-slip state so as to cause the transfer clutch device 32 to transition from the slip engagement state to the direct engagement state.

As described above, in the second special start control, the actual rotational speed difference ΔW between the two clutch members of the transfer clutch device 32 is reduced to the synchronization determination differential rotational speed ΔNs or less, and then the engagement pressure of the transfer clutch device 32 is gradually increased. Therefore, the direct engagement of the transfer clutch device 32 can be performed gently. Moreover, the rotational speed Ne of the internal combustion engine EG is increased once so as to be higher than the rotational speed of the rotary electric machine 33, and then the transfer clutch device 32 is directly engaged. Therefore, the direction of torque transfer via the transfer clutch device 32 is invariant before and after the direct engagement. Therefore, the difference in level of the torque to be transferred to the shift input member 34 can be minimized before and after the direct engagement as compared with a case where the transfer clutch device 32 is directly engaged in a situation in which the rotational speed Ne of the internal combustion engine EG is lower than the rotational speed of the rotary electric machine 33. Accordingly, even in the case where the transmission device 35 is maintained at the non-slip state as described in the present embodiment, it is possible to minimize torque fluctuation to be transferred to the wheels W and to reduce an engagement shock incident to the direct engagement of the transfer clutch device 32.

When the actual rotational speed difference ΔW between the two clutch members of the transfer clutch device 32 becomes zero (T06) with the increase in the engagement pressure of the transfer clutch device 32, the oil pressure command value is increased such that the engagement pressure of the transfer clutch device 32 becomes a full engagement pressure, and then the internal combustion engine start control is terminated.

### Other Embodiments

(1) In the foregoing embodiment, the description has been given of, as an example, the configuration in which the first special start control and the second special start control are performed in parallel so as to partially overlap each other. However, the present invention is not limited to this configuration. For example, the second special start control may be performed after the termination of the first special start control.

(2) In the foregoing embodiment, the description has been given of, as an example, the configuration in which the oil pressure command value for the transfer clutch device 32 is reduced to become zero before the reverse in the direction of relative rotation, in the second special start control. However, the present invention is not limited to this configuration. For example, the oil pressure command value for the transfer clutch device 32 may be reduced to a stroke end pressure that is a hydraulic oil pressure immediately before a transfer torque starts to be generated at the transfer clutch device 32. This configuration has an advantage that when a necessity arises to re-engage the transfer clutch device 32 later, the transfer clutch device 32 can be re-engaged with good responsivity.

(3) In the foregoing embodiment, the description has been given of, as an example, the configuration in which the engagement pressure of the transfer clutch device 32 is reduced to become zero before the reverse in the direction of relative rotation, in the second special start control. However, the present invention is not limited to this configuration. For example, the engagement pressure of the transfer clutch device 32 may be reduced to become equal to or less than a set torque that is previously determined. In this case, preferably, the set torque is set to be equal to or less than a half of a minimum value of a difference in level of a torque that may deliver a shock to an occupant of the vehicle, for example.

(4) In the foregoing embodiment, the description has been given of, as an example, the configuration in which the rotational speed Ne of the internal combustion engine EG is increased once so as to be higher than the rotational speed of the rotary electric machine 33, and then the transfer clutch device 32 is directly engaged, in the second special start control. However, the present invention is not limited to this configuration. For example, the transfer clutch device 32 may be directly engaged in a situation in which the rotational speed Ne of the internal combustion engine EG is lower than the rotational speed of the rotary electric machine 33.

(5) In the foregoing embodiment, the description has been given of, as an example, the configuration in which the target rotational speed Net in the rotational speed control for the internal combustion engine EG is set at the rotational speed higher by the certain synchronization determination differential rotational speed ΔNs than the rotational speed Nin of the shift input member 34, in the second special start control. However, the present invention is not limited to this configuration. For example, the target rotational speed Net of the internal combustion engine EG may be set at a rotational speed higher by a variable differential rotational speed that gradually decreases with time relative to the rotational speed Nin of the shift input member 34.

(6) Specific settings for, for example, the startable rotational speed Nsu, set start rotational speed Nst, and synchronization determination differential rotational speed ΔNs described in the foregoing embodiment may be appropriately set in accordance with, for example, running characteristics required of a vehicle.

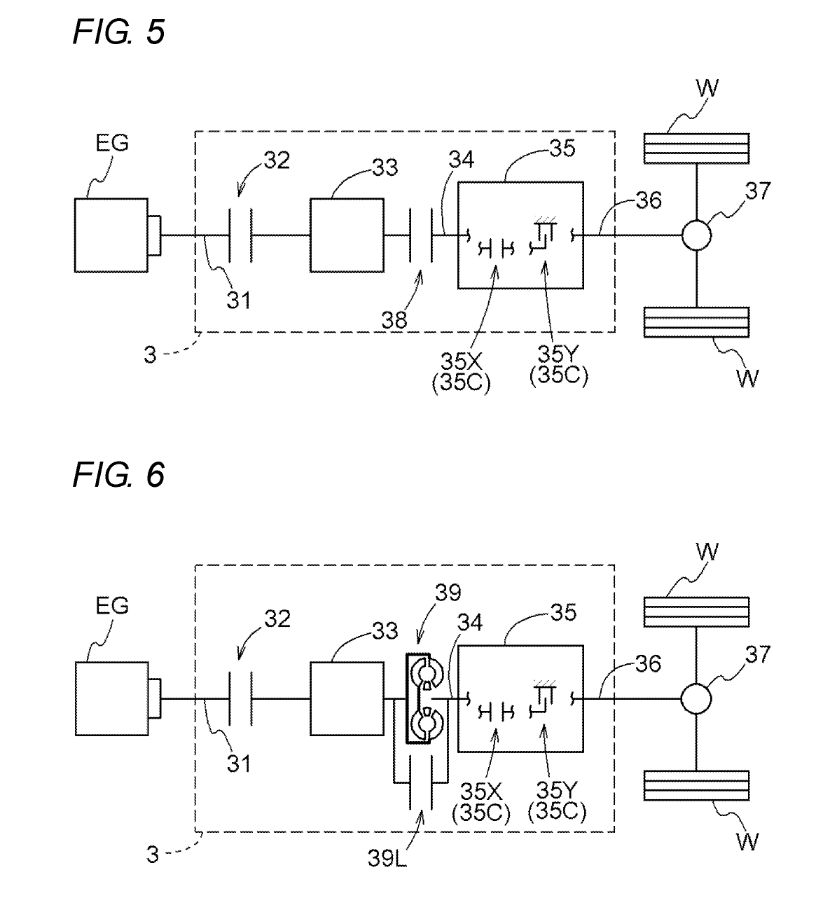

(7) In the foregoing embodiment, the description has been given of an example of the control target, that is, the vehicle drive device 3 in which only the disconnection clutch device 32 is provided as a clutch device to be disposed on the power transfer path connecting the internal combustion engine EG to the wheels W, except for the shift clutch devices 35C. However, the present invention is not limited to this configuration. In the vehicle drive device 3 as a control target, as illustrated in, for example, FIG. 5, a second disconnection clutch device 38 may be additionally disposed on the power transfer path between the internal combustion engine EG and the transmission device 35.

Alternatively, as illustrated in, for example, FIG. 6, a hydraulic coupling 39 (e.g., a torque converter, a fluid coupling) having a direct-coupling clutch device 39L may be additionally disposed on the power transfer path between the internal combustion engine EG and the transmission device 35. In these cases, each of the second disconnection clutch device 38 and the direct-coupling clutch device 39L is maintained at the direct engagement state (one aspect of the non-slip engagement state) during the performance of the internal combustion engine start control.

(8) In the foregoing embodiment, the description has been given of, as an example, the configuration in which any two of the plurality of shift clutch devices 35C are brought into the direct engagement state to establish a target shift speed. However, the present invention is not limited to this configuration. For example, one shift clutch device 35C or at least three shift clutch devices 35C may be brought into the direct engagement state to establish a target shift speed.

(9) In the foregoing embodiment, the description has been given of an example of the control target, that is, the vehicle drive device 3 including, as the transmission device 35, the stepped automatic transmission device of the type provided with the planetary gear mechanism and the plurality of shift clutch devices 35C. However, the present invention is not limited to this configuration. The vehicle drive device 3 as a control target may include, as the transmission device 35, a stepped automatic transmission device of another type, such as a dual clutch transmission (DCT).

It should be noted that the configuration disclosed in each of the foregoing embodiments (including the foregoing embodiments and other embodiments; the same applies to the following description) may be applied in combination with a configuration disclosed in any other embodiment unless any contradiction occurs.

Regarding other configurations as well, it should be understood that the embodiments disclosed in the specification are merely by way of example in all aspects. Accordingly, those skilled in the art can appropriately make various modifications without departing from the spirit of the present disclosure.

### Outline of Embodiments

To summarize the above, a control device according to the present disclosure preferably has the following configuration.

[1]

A control device (1) for controlling a vehicle drive device (3), as a control target, including a transfer clutch device (32), a rotary electric machine (33), and a transmission device (35) that includes one or more shift clutch devices (35C) on a power transfer path connecting an internal combustion engine (EG) to a wheel (W),

a state in which, of the shift clutch devices (35C), all shift clutch devices (35C) to be engaged in a situation in which the transmission device (35) transfers power are directly engaged without being slipped is defined as a non-slip state of the transmission device (35),

the control device (1) being configured to, in a situation in which the transfer clutch device (32) is in a disengagement state, a situation in which a rotational speed of the rotary electric machine (33) is equal to or more than a startable rotational speed (Nsu) of the internal combustion engine (EG), and a situation in which the transmission device (35) is in the non-slip state and a torque of the rotary electric machine (33) is transferred to the wheel (W) to drive a vehicle, perform internal combustion engine start control of bringing the transfer clutch device (32) into a slip engagement state and increasing a rotational speed (Ne) of the internal combustion engine (EG) to start the internal combustion engine (EG),

the control device (1) being configured to set a target torque (Tmt) that is a target value of an output torque from the rotary electric machine (33) at a sum of a wheel required torque (Tw) that is a torque required for driving the wheel (W) and a transfer torque of the transfer clutch device (32) in the slip engagement state to control the output torque from the rotary electric machine (33), during the performance of the internal combustion engine start control,

the control device (1) being configured to perform rotational speed control on the internal combustion engine (EG) to increase the rotational speed (Ne) of the internal combustion engine (EG) to a rotational speed higher than the rotational speed of the rotary electric machine (33) in a pre-transition completion period before the transfer clutch device (32) in the slip engagement state is transitioned to a direct engagement state, while maintaining the transmission device (35) at the non-slip state, after the start of the internal combustion engine (EG),

the control device (1) being configured to reduce an engagement pressure of the transfer clutch device (32) such that the transfer torque of the transfer clutch device (32) becomes zero, on a reverse in a direction of relative rotation, at which the gradually increasing rotational speed (Ne) of the internal combustion engine (EG) becomes higher than the rotational speed of the rotary electric machine (33), in the pre-transition completion period.

With this configuration, during the performance of the internal combustion engine start control, all the shift clutch devices to be engaged in the situation in which the transmission device transfers power are maintained at the state being directly engaged without being slipped. None of the shift clutch devices are slipped to begin with. Therefore, there is no possibility that torque fluctuation incident to slip start and re-direct coupling is transferred to the wheel to cause a shock.

Moreover, a combination of rotational speed control for the rotary electric machine with the control for the output torque from the rotary electric machine with the wheel required torque and the transfer torque of the transfer clutch device taken into consideration enables minimization of the range of fluctuation in an input torque to the transmission device. It is hence possible to minimize the torque fluctuation to be transferred to the wheel and to reduce a shock, without causing the shift clutch device to be slipped, in the period before starting the internal combustion engine.

It is accordingly possible to reduce a shock to be delivered to an occupant of the vehicle, in the entire period from the pre-transition completion period to the timing at which the transfer clutch device is directly engaged.

In addition, the rotational speed of the internal combustion engine is increased once to the rotational speed higher than the rotational speed of the rotary electric machine, in the pre-transition completion period. Therefore, the direction of torque transfer via the transfer clutch device is invariant before and after the direct engagement of the transfer clutch device. It is hence possible to minimize a difference in level of a torque to be input to the transmission device before and the after the direct engagement of the transfer clutch device. It is therefore possible to reduce an engagement shock incident to the direct engagement of the transfer clutch device.

In this case, the transfer torque of the transfer clutch device brought into the slip engagement state in order to start the internal combustion engine is brought to be zero on the reverse in the direction of relative rotation, at which the direction of relative rotation between the internal combustion engine and the rotary electric machine is reversed. It is hence possible to avoid occurrence of a difference in level of a torque before and after the reverse in the direction of relative rotation, at which a difference in level inevitably occurs at a torque to be input to the transmission device in a case where the transfer clutch device has a transfer torque.

It is accordingly possible to start the internal combustion engine without causing an occupant of the vehicle to feel a shock in a case where a request to start the internal combustion engine comes in.

A control device according to the present disclosure may be capable of producing at least one of the advantageous effects described above.

### REFERENCE SIGNS LIST

1: control device
3: vehicle drive device
14: start control part
15: transfer torque estimation part
32: transfer clutch device
33: rotary electric machine
35: transmission device
35C: shift clutch device
EG: internal combustion engine
W: wheel
Ne: rotational speed of internal combustion engine
Nin: rotational speed of shift input member (rotational speed of rotary electric machine)
Net: target rotational speed of internal combustion engine
Nmt: target rotational speed of rotary electric machine
Tmt: target torque of rotary electric machine
Tw: wheel required torque
Tp: estimated transfer torque of transfer clutch device
Nsu: startable rotational speed
ΔNs: synchronization determination differential rotational speed
ΔW: rotational speed difference between clutch members of transfer clutch device

1. A control device for controlling a vehicle drive device, as a control target, including a transfer clutch device, a rotary electric machine, and a transmission device that includes one or more shift clutch devices, on a power transfer path connecting an internal combustion engine to a wheel,
a state in which, of the shift clutch devices, all shift clutch devices to be engaged in a situation in which the transmission device transfers power are directly engaged without being slipped is defined as a non-slip state of the transmission device,
the control device being configured to, in a situation in which the transfer clutch device is in a disengagement state, a situation in which a rotational speed of the rotary electric machine is equal to or more than a startable rotational speed of the internal combustion engine, and a situation in which the transmission device is in the non-slip state and a torque of the rotary electric machine is transferred to the wheel to drive a vehicle, perform internal combustion engine start control of bringing the transfer clutch device into a slip engagement state and increasing a rotational speed of the internal combustion engine to start the internal combustion engine,
the control device being configured to set a target torque that is a target value of an output torque from the rotary electric machine at a sum of a wheel required torque that is a torque required for driving the wheel and a transfer torque of the transfer clutch device in the slip engagement state to control the output torque from the rotary electric machine, during the performance of the internal combustion engine start control,
the control device being configured to perform rotational speed control on the internal combustion engine to increase the rotational speed of the internal combustion engine to a rotational speed higher than the rotational speed of the rotary electric machine in a pre-transition completion period before the transfer clutch device in the slip engagement state is transitioned to a direct engagement state, while maintaining the transmission device at the non-slip state, after the start of the internal combustion engine,
the control device being configured to reduce an engagement pressure of the transfer clutch device such that the transfer torque of the transfer clutch device becomes zero, on a reverse in a direction of relative rotation, at which the gradually increasing rotational speed of the internal combustion engine becomes higher than the rotational speed of the rotary electric machine, in the pre-transition completion period.
